(19) United States
(12) Patent Application Publication
(10) Pub. No.: US 2011/0126168 A1
(43) Pub. Date: May 26, 2011

(54) CLOUD PLARFORM FOR MANAGING SOFTWARE AS A SERVICE (SAAS) RESOURCES

(75) Inventor: Emanuel ILYAYEV, Beit-Shemesh (IL)

(73) Assignee: CROWDSOURCE TECHNOLOGIES LTD., Beit-Shemesh (IL)

(21) Appl. No.: 12/951,131

(22) Filed: Nov. 22, 2010

Related U.S. Application Data
(60) Provisional application No. 61/264,265, filed on Nov. 25, 2009.

(51) Int. Cl. G06F 9/44; G06F 15/16

(52) U.S. Cl. 717/103

(57) ABSTRACT

A cloud platform for managing Software as a Service (SaaS) resources is provided herein. The platform includes: a mediator server connected to computing resources, arranged to provide software developers a platform to develop SaaS applications, operable on the computing resources, wherein the SaaS applications and customer data are stored logically and physically independent of the computing resources, and data of SaaS application and the customer data are logically and physically separated. SaaS platform allows developers to provide software solutions via the mediator server directly to customers, and ensures data availability and data security. Access policy of users and developers to SaaS applications is centrally supervised and capable of integrating with other applications on the site of the customer. Upgrades to SaaS applications are performed in a predefined order of customers. Further, the SaaS platform facilitates selection and replacement of data storage provider.

### BACKGROUND

1. Technical Field

The present invention relates to the field of cloud computing, and more particularly, to a platform for managing Software as a Service applications in a cloud computing environment.

2. Discussion of Related Art

SaaS is a Software Application (SA) supplied by a service provider, namely, a SaaS Vendor. The service is supplied and consumed over the internet, thus canceling requirements to install and run applications on a site of a customer as well as simplifying maintenance and support. Particularly it is advantageous in massive business applications. Licensing is a common form of billing for the service and it is paid periodically.

SaaS is becoming ever more common as a form of SA delivery over the internet and is being facilitated in a technology infrastructure called “Cloud Computing”. In this form of SA delivery, where the SA is controlled by a service provider, a customer may experience stability and data security issues. In many cases the customer is a business organization that is using the SaaS for business purposes i.e. business software hence, stability and data security are primary requirements.

Prior to setting forth the background of the related art, it may be helpful to set forth definitions of certain terms that will be used hereinafter.

The term “Cloud computing” as used herein in this application, is defined as a technology infrastructure facilitating supplement, consumption and delivery of IT services. The IT services are internet based and involve elastic provisioning of dynamically scalable and many a time virtualized resources.

The term “Software as a Service (SaaS)” as used herein in this application, is defined as a model of software deployment whereby a provider licenses a SA to customers for use as a service on demand.

The term “customer” as used herein in this application, is defined as a business entity that is served by a SA, provided on the SaaS platform. A customer may be a person or an organization and may be represented by a user that responsible on the administration of the application in aspects of permissions configuration, user related configuration, and data security policy.

The term “user” as used herein in this application, is defined as an entity that is delegated by the customer to utilize a SA provided on the SaaS platform.

The term “multi-tenancy” as used herein in this application, is defined as a software architecture where a single instance of the software runs on a server, which is serving multiple customers. In a multi-tenant environment, all customers and their users consume the service from the same technology platform, sharing all components in the technology stack including the data model, servers, and database layers. Further, in a multi-tenant architecture, a SA is designed to virtually partition its data and configuration, and each customer works with a customized virtual application instance. Some attributed benefits of this architecture are: reduce hardware costs, simplifying installation and maintenance.

The term “SaaS Platform” as used herein in this application is defined as a computer program that acts as a host to SAs that reside on it. Essentially, a SaaS platform can be considered as a type of specialized SA server. The platform manages underlying computer hardware and software resources and uses these resources to provide hosted SAs with multi-tenancy and on-demand capabilities, commonly found in SaaS applications. Generally, the hosted SAs are compatible with SaaS platform and support a single group of users. The platform holds the responsibility for distributing the SA as a service to multiple groups of users over the internet. The SaaS Platform can be considered as a layer of abstraction above the traditional application server, creating a computing platform that parallels the value offered by the traditional operating system, only in a web-centric fashion. The SaaS platform responds to requirements of software developers. The requirements are to reduce time and difficulty involved in developing highly available SAs, and on-demand enterprise grade business SAs.

The term “Application Programming Interface (API)” as used herein in this application, is defined as an interface that a software program implements to allow a software to interact with it; much in the same way that software might implement a user interface in order to allow humans to interact with it. APIs are implemented by SAs, libraries and operating systems to define how other software can make calls to or request services from them. An API determines the vocabulary and calling conventions that the programmer should employ in order to use the services. It may include specifications for routines, data structures, object classes, and protocols used to communicate between a consumer and an implementer of the API.

The term “software developer” as used herein in this application, is defined as a person, a group or an organization that are concerned with facets in software development process. The term may also include a business entity that offers the software that was developed by the developer on the SaaS platform.

The term “delta” as used herein in this application, is defined as a finite increment in a variable.

The term “A record” as used herein in this application, is defined as an entry in a Domain Name System (DNS) zone file that maps each domain name or subdomain to an IP address.

The term “Canonical Name (CNAME)” as used herein in this application, is defined as a record in a DNS database that indicates the true or canonical, host name of a computer that its aliases are associated with.

The term “wildcard DNS record” as used herein in this application, is defined as a record in a DNS zone that will match requests for non-existent domain names.

The term “ID” as used herein in this application, is defined as a unique identification of a user or a customer.

### BRIEF SUMMARY

Embodiments of the present invention provide a system for managing Software as a Service (SaaS) resources, comprising: a mediator server connected to a plurality of computing resources, arranged to allow software developers to develop SaaS applications operable on computing resources, and further arranged to allow customers to use the developed SaaS applications with specified customer data, wherein the SaaS application data and the customer data may be logically and physically separated, and wherein the system is arranged to allow the software developers to provide the SaaS applications via the mediator server directly to the customers, and ensures data availability and data security with any data storage provider that may be selected and replaced by the customer at any time. Replacement of data storage provider is handled in a procedure that provides relatively fast transfer of data from current data storage provider to a new data storage provider.

According to an aspect of the present invention, there is provided a system, wherein the mediator server is further arranged to separate data that is related to each SaaS application into an application zone data and customer zone data. In this model users are grant with free access to the customer zone data, and user access to the application zone data may be supervised.

Further, separation of the data allows the mediator server to bill for application usage. For example, the application zone data may include a user interface, biz logic and a data connector to data structures, while the customer zone data may include data structures and a data API. Elements in the application zone data may retrieve information from the data structures located in the customer zone data via the data connector. The data connector receives information from the data structures via the data API. In this architecture data is also accessible for the customer not via the application. The data API is arranged to manage storage of the customer zone data on various cloud hosting providers in a user transparent mode.

Embodiments of the present invention provide a method of managing SaaS computing resources, comprising: receiving SaaS applications from software developers and providing SAs to customers; running the SAs on a plurality of computing resources; physically and logically separating data related to each SaaS application into application zone data and customer zone data; allowing the customer to select the storage of the customer zone data; and controlling user access to the application zone data. The method is arranged to allow the software developers to directly provide the SAs to the customers, and to ensure availability and security of the customer zone data, independently of the computing resources. The SAs are transferred in a transparent and automatic manner minimizing significantly the necessary downtime of the SAs.

Accordingly, according to an aspect of the present invention, there is provided a method, further comprising providing a development platform for software developers and supporting the developed SAs; and allowing the customer to select and replace a provider of data storage.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a system for managing Software as a Service (SaaS) resources, according to some embodiments of the invention;

FIG. 2 is a high level flowchart illustrating a method of managing SaaS resources, according to some embodiments of the invention;

FIG. 3 is a high level schematic block diagram of a SaaS applications development platform, according to some embodiments of the invention;

FIG. 4 is a high level flowchart illustrating a process of installation and deployment of SaaS applications on the cloud hosting provider chosen by the customer of the application, according to some embodiments of the invention;

FIG. 5 is a high level schematic flowchart illustrating data synchronization upon transferring data and the corresponding application between an initial and an actual customer zone host, according to some embodiments of the invention;

FIG. 6 is a block diagram illustrating architecture of the SaaS platform;

FIG. 7 is a high level schematic flowchart illustrating a process of Hyper Text Transfer Protocol (HTTP) request invoked in each application login;

FIG. 8 is a high level schematic flowchart illustrating a process of HTTP request invoked in each application usage;

FIG. 9A is a high level schematic flowchart illustrating an upgrading of the SaaS application by a rolling upgrade. This method reduces the load of technical support and customer service generally arises after an application upgrade; and

FIG. 9B is a high level block diagram illustrating a process of version upgrade in SaaS platform.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

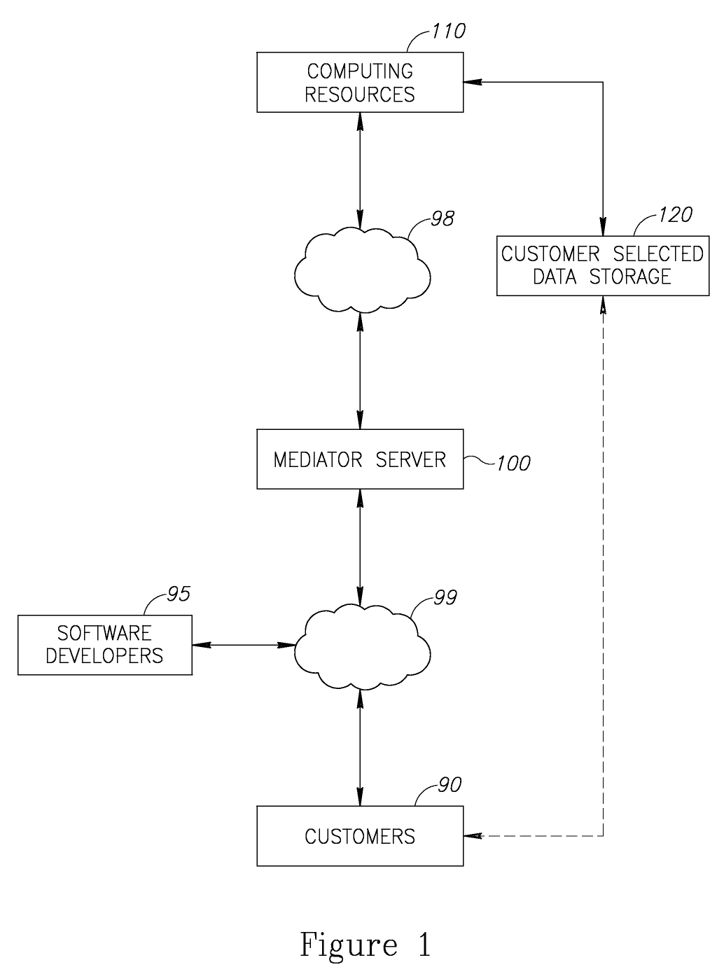

FIG. 1 is a high level schematic block diagram of a system for managing Software as a Service (SaaS) resources, according to some embodiments of the invention. The system comprises a mediator server 100 connected to a plurality of computing resources 110, via a communication link 98. Mediator server 100 is arranged to allow Software Developers (SD) 95 to develop SaaS applications operable on computing resources 110, and to allow customers 90 to consume developed SaaS applications with associated customer data. Communication with SD 95 and customers 90 may be carried out via a communication link 99, which may be similar or different from communication link 98. Data related to SaaS applications and customer data may be stored logically and physically independent of computing resources 110. The system is arranged to allow SD 95 to provide software solutions via mediator server 100 directly to customers 90, and ensures delivery of data in a secure manner, operable on customer selected Data Storage Servers (DSS) 120. The data is available independently of computing resources 110 that run the SaaS applications. Each Software Application (SA) is running on a server connected to the server hosting the data associated with the application (i.e., the customer selected DSS 120) via a communication link, such as a Local Area Network (LAN) or virtual Local Area Network (vLAN) while maintaining a speed of operation of the SAs as agreed upon in a Service Level Agreement (SLA). The customer 90 may define access permissions to data on customer selected DSS 120 and to control the data availability and security.

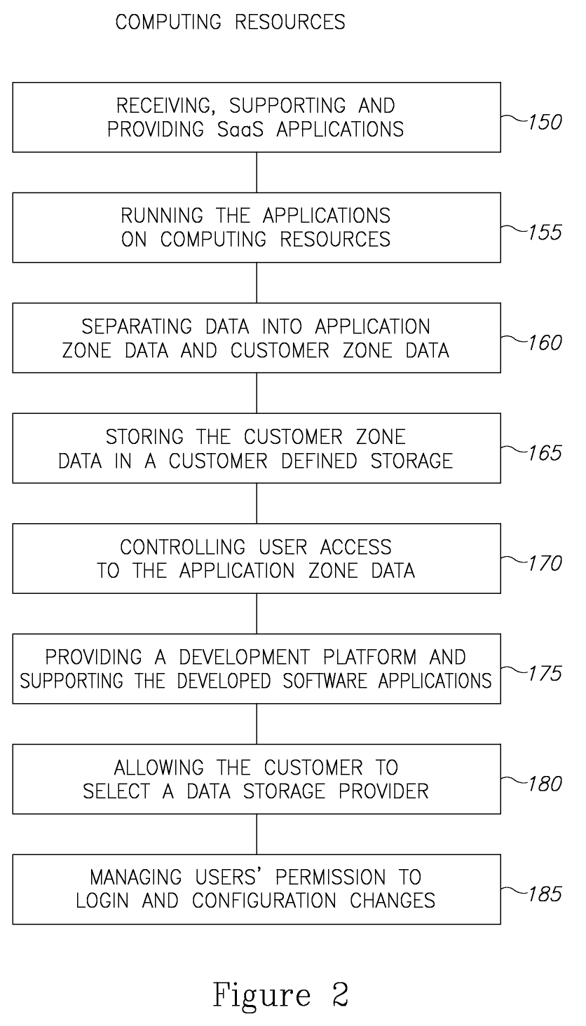

FIG. 2 is a high level flowchart illustrating a method of managing SaaS resources, according to some embodiments of the invention. The method comprises the following stages: receiving SaaS applications from SD and providing SAs to customers (stage 150); running the SAs on a plurality of computing resources (stage 155); separating data of each SaaS application into application zone data and customer zone data (stage 160); storing the customer zone data in a customer selected DSS accessible to the customer (stage 165); and controlling user access to the application zone data (stage 170). The customer selected DSS is logically and physically independent of the computing resources, and the method is arranged to allow the following features: SDs to provide the SAs directly to the customers and to ensure availability and security of the customer zone data.

According to some embodiments of the invention, the method further comprises providing a development platform for SD and supporting the developed SAs (stage 175).

According to some embodiments of the invention, the method further comprises allowing the customer to select a data storage provider (stage 180); managing permissions of users to login to the SA and configuring changes (stage 185). In stage 185 the customer may configure permissions to login to the application via an Access Control List (ACL), add or remove users, add or remove features from the application, change functionality of some of the SAs modules and the like. Further, the changes in the configuration of the SA may trigger changes in billing specifications that were agreed with the service provider.

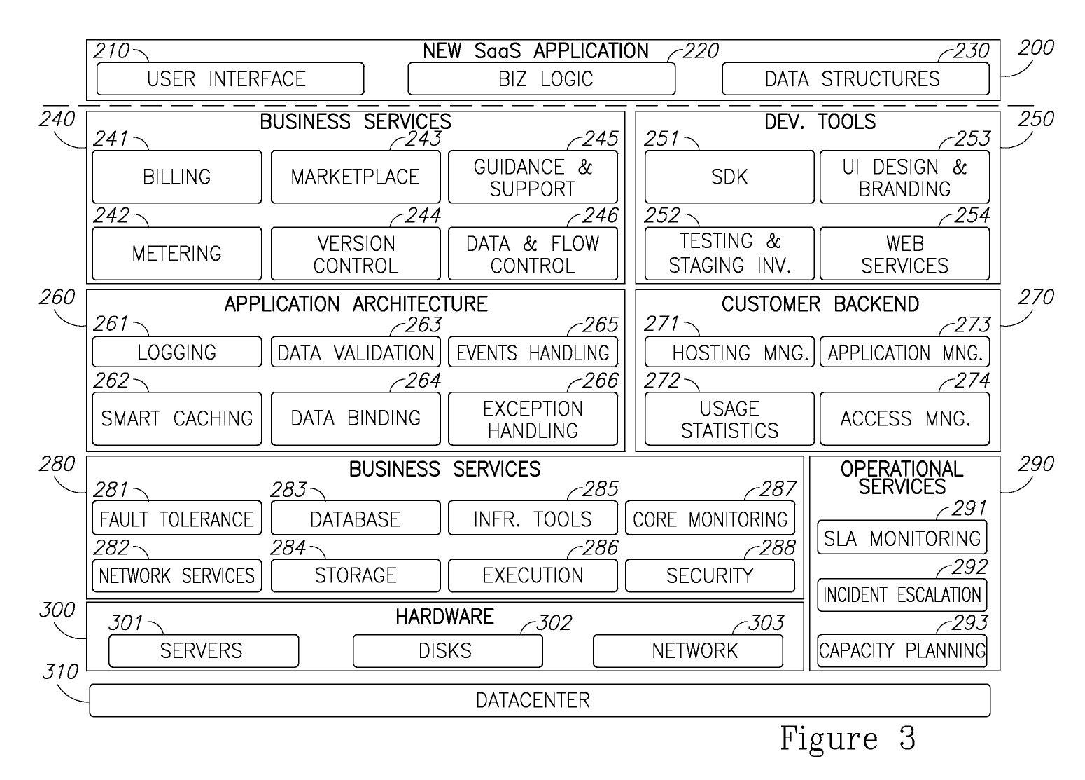

FIG. 3 is a high level schematic block diagram of a SaaS applications development platform, according to some embodiments of the invention. For generating a new SaaS application 200, SDs 95 in FIG. 1 may define a user interface 210, biz logic 220 and data structures 230. The platform supplies a wide range of tools for SDs 95 to construct a new SaaS application 200 according to these specifications. These tools comprise, in a non-limiting example: Business services 240 (tools for billing 241, metering 242, marketplace 243, version control 244, guidance and support 245 and for data and flow control 246), developing tools 250 (Software Development Kit (SDK) 251, testing and staging environment 252, tools for user interface design and branding 253 and various collection of web services that saves time and efforts on the development process 254), application architecture 260 (logging 261, smart caching 262, data validation 263, data binding 264, event handling 265 and exception handling 266), customer backend 270 (comprising, e.g., hosting management 271, usage statistics 272, application management 273 and access management 274), operating system and core infrastructure 280 (fault tolerance 281, network services 282, database 283, storage 284, infrastructure tools 285, execution 286, core monitoring 287 and security 288), operational services 290 SLA monitoring 291, incident escalation 292 and capacity planning 293), hardware—physical or virtual 300 (servers 301, disks 302 and network 303) as well as datacenters 310.

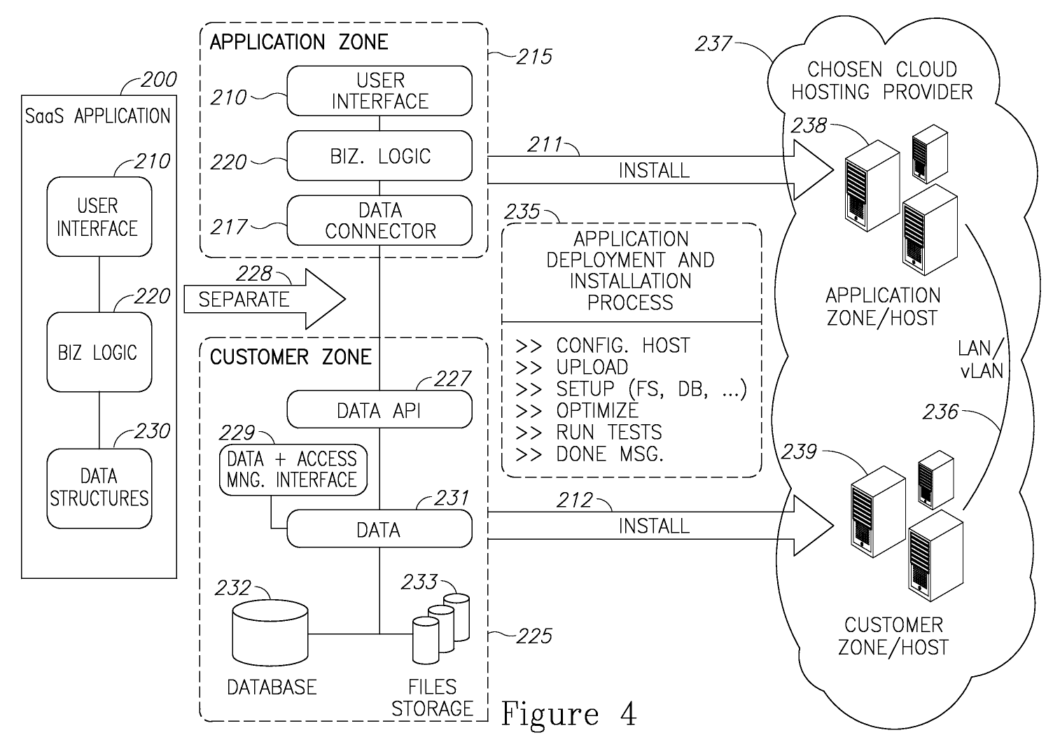

FIG. 4 is a high level flowchart illustrating a process of installation and deployment of SaaS applications on the DSS i.e. cloud hosting provider 237 chosen by the customer of the application, according to some embodiments of the invention. The system may separate data related to each new SaaS application 200 in FIG. 3 (arrow 228, data generally referring to content as well as to user interface 210, biz logic 220 and data structures 230 into application zone data 215 and customer zone data 225. For example, application zone data 215 may comprise user interface 210, biz logic 220 and a data connector 217 arranged to communicate with a data Application Programming Interface (API) 227. Data API 227 is arranged to allow data connector 217 operate data 231, as well as content from databases 232 and file storage 233. Further, the customer may operate data 231, content from databases 232 and file storage 233 independently of new SaaS application 200 in FIG. 3, via data management Interfaces 229 or directly. Data 231, databases 232 and file storage 233 may be part of customer selected DSS 120 and may be provided from the system or from external providers. Customer defined DSS may be logically and physically independent of computing resources that are running SaaS applications to allow the customer to operate data 231 and content from databases 232 and file storage 233 not via SaaS application 200 in FIG. 3. The separation of data into application zone data 215 and customer zone data 225 with control of user access to application zone data 215, allows the system to bill for application usage while allowing the customer to access the raw data independently.

According to some embodiments of the invention, data API 227 is arranged to manage data and content storage by operating databases 232 and file storage 233 on various DSS i.e. cloud hosting providers 237. During a process of data separation 228, data and content such as files, tables and other data objects, as well as metadata of new SaaS application 200 in FIG. 3, may be wrapped by data API 227. These data and content may be made accessible to both SD 95 in FIG. 1 and associated customer users 90 in FIG. 1 (the latter via a data an interface 229). Interface 229 may allow customer 90 in FIG. 1 define and manage access permissions to database 232, file storage 233 and data 231. Customer 90 in FIG. 1 may further define access permissions to external SAs, thus, enhancing the interoperability of the system.

After the process of data separation 228, application zone 215 is installed (211) at an application zone host 238 and customer zone 225 is installed (212) at a customer zone host 239. Application zone host 238 and customer zone host 239 may both be part of a chosen DSS i.e. cloud hosting provider 237, and may be separated logically and physically, while connected via a communication link 236, e.g., a LAN or a vLAN. During installations (211) and (212) operations relating to new SaaS application 200 in FIG. 3 and actions of a customer may be analyzed and optimized, and cloud hosting providers 237 may be managed in respect to the analysis and optimization in a user transparent mode. Installations (211) and (212) may further comprise configuring a hosting solution, uploading new SaaS application 200 in FIG. 3 to hosting servers 238, 239, setting up the file systems and optimizing the content in relation to hosting servers 238, 239, and also run tests and notify the customer of the actions taken.

Connecting customer zone host 239 and application zone host 238 on a common LAN 236 (as an example) may be facilitated by data API 227 that may modify and translate new SaaS application 200 in FIG. 3 to be operable on any server in cloud 237. The placing of new SaaS application 200 in FIG. 3 (selection of host 238) is carried out according to the placing of the data by the customer (on customer zone host 239). The proximate placing (on a common LAN 236, as an example) of customer zone host 239 and application zone host 238 allows them to sustain a high communication rate that may enable the implementation and effective operation of new SaaS application 200 in FIG. 3.

Selection and replacement of data storage provider may derive from various factors such as regulatory, operational and financial conditions. An example of a regulatory restriction may be a prohibition on storing data on servers that are located outside of the country of the customer. An example of an operational restriction may be reducing latency by locating the datacenter close to the customer. An example of a financial condition may be a data storage provider that is charging a lower price for his services compared to current data storage provider.

Another case where the selection and replacement of data storage provider is required is when a customer is interested in the SaaS application running on a private cloud computing running infrastructure on the site of the customer. In this case, data security is performed by security and control systems of the customer.

According to some embodiments of the invention, customer zone host 239 may belong to one of customers 90 in FIG. 1, which may determine its accessibility permissions, while application zone host 238 may belong to an operator of the system, with a controlled access to customers 90 and developers 95 in FIG. 1. Hosting servers 238, 239 may be logically and physically separated from each other, and may be dedicated to specific customers, or may be hosted together (and/or for groups of customers 90) and separated logically only.

Data API 227 is further arranged to control computing resources (e.g. storage, CPU) dedicated to each new SaaS application 200, and manage usage of costs accordingly. Data API 227 as a central component of the SaaS platform is arranged to allow analysis and comparison of costs related to each new SaaS application 200, and thus allow a reliable pricing of the computing resources.

The system and platform may further provide developers 95 in FIG. 1 with various customer support tools including manuals, download managers, instruction means and managing and control tools.

The system operates elements in FIG. 1 such that it allows SDs 95 to provide software solutions via mediator server 100 directly to customers 90, and ensures data availability and data security, logically and physically independent of computing resources that operates the SAs. Advantageously, the system may raise trust of customers 90 by allowing them to keep their data and define access permissions to the data themselves. In particular, developers 95 may be prevented from approaching the data, and are thus easily replaceable in the customer's view with minimal or no damage to the data and the functioning of new SaaS application 200.

Furthermore, the SDs may be able to effectively manage and price new SaaS application 200 and services provided by them 95. The system further ensures customers 90 by providing an independent quality assurance of the work of SDs 95. SDs 95 themselves may enjoy the enhanced reliability of the proposed system to attract customers through the system.

In addition, version updating may be carried out in relation to customer specifications, as each application for each one of customers 90 may be managed for itself (there is not necessarily a single central application for all customers 90). The system may allow using a single tenancy model to hosts 238, 239 thus providing a highly personalized, secure and efficiently priced solution for customers 90. The system may allow using any other model of data and application storage, such as multi-tenancy and isolated tenancy.

Since SaaS platform runs the SaaS application in a multi-tenant environment, SaaS application installation for a new customer requires several operations such as database installation, configuration, computing and storage resources allocation and other operations that may lengthen the installation time. Therefore, installation process is optimized and provided on-demand by pre-installation of a customer and then performing minor changes in metadata of the SaaS application and certain configurations for new customers.

In cases of a customer initiating transfer of customer selected DSS 120 (customer zone host 239), new SaaS application 200 in FIG. 3 and application zone host 238 are also transferred to a new application zone host 238 on a common communication link 236 (such as LAN) with the new customer zone host 239. Thus, the effectivity of new SaaS application 200 is maintained. The transfer itself requires a synchronization of data between the hosts.

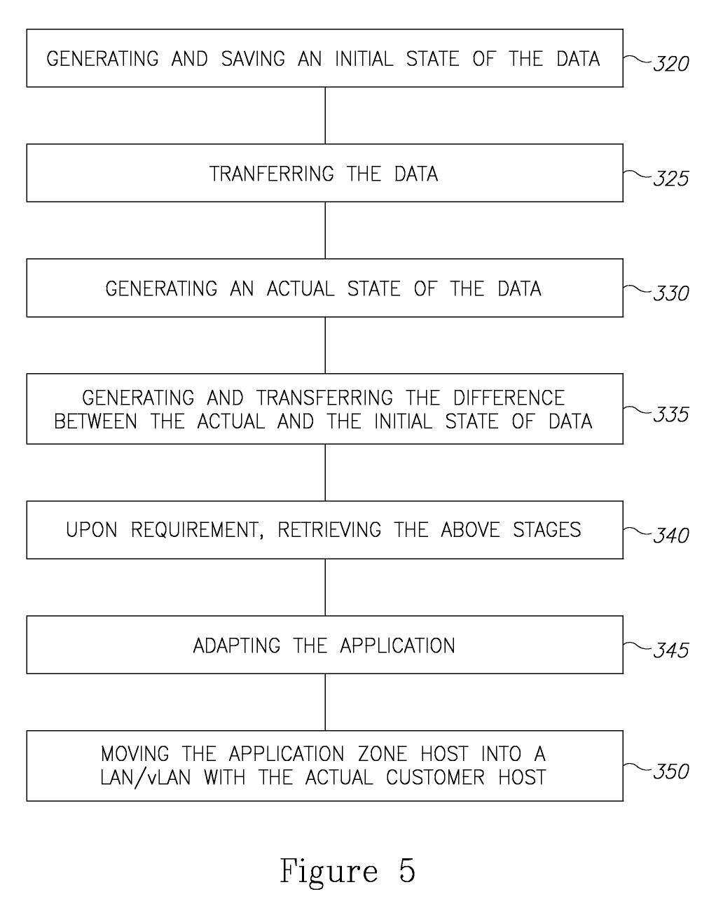

FIG. 5 is a high level schematic flowchart illustrating data synchronization upon transferring data and the corresponding application between an initial and an actual customer zone host, according to some embodiments of the invention. The method comprises the following stages: generating and saving an initial state of the data (Data Snapshot) on the initial customer zone host (stage 320); transferring the data snapshot from current customer zone host to a new customer zone host (stage 325); generating an actual state of the data on the initial customer zone host (stage 330); generating and transferring the difference between the actual and the initial states of the data to the actual customer zone host (stage 335), whereupon the actual customer zone host may start operating with the actual state of data synchronized. If necessary, as the more data updates have accumulated during the transfer of the difference (stage 335), the above stages (stages 320, 325, 330) may be reiterated (stage 340). After data has been transferred, the application and the configuration of the application may be adapted to the new data storage provider (stage 345) and moved to an actual application zone host which is in a LAN/vLAN with the actual customer host (stage 350). The transfer may require further stages such as a smooth transfer of sessions and reconfiguring caches. Furthermore, the difference may be used to update the SAs and ensure back-compliance to former versions.

In order to reduce to minimum the delay time of transferring the data related to the application, to another data storage provider, the following steps are taken. A process of creating a database snapshot is performed, similarly to database backup process i.e. the creation and maintenance of multiple copies of the same database that occurs during runtime and does not require the system to stop. After database snapshot creation (stage 320), changes in the database i.e. a delta, are being tracked and a script may produce it. In cases of a large database, in which the delta may be too large, after creating the first delta, another one is iteratively created and then repeating this stage (stage 340).

This algorithm assumes that there were no changes in the database between the creation of a snapshot of the database and the delta creation. In order to handle changes in the database that occurred between the creation of the snapshot of the database and the delta creation, the following steps may be taken. Once a database schema is updated the system saves the delta and then runs database schema migration script and saves it with first delta. When transferring the data snapshot (stage 325) ends and generating an actual state of the data (stage 330) of the new database, the system creates an additional delta that includes the changes that were performed after the changes in the database. The additional delta and the original delta with the database schema migration script will be sent to the new data storage server.

In the new database, located on the new DSS the system will run a script for the original delta, then a database schema migration script and then a script for the additional delta (stage 335). In case the delta script runtime is too long the process may be repeated (stage 340).

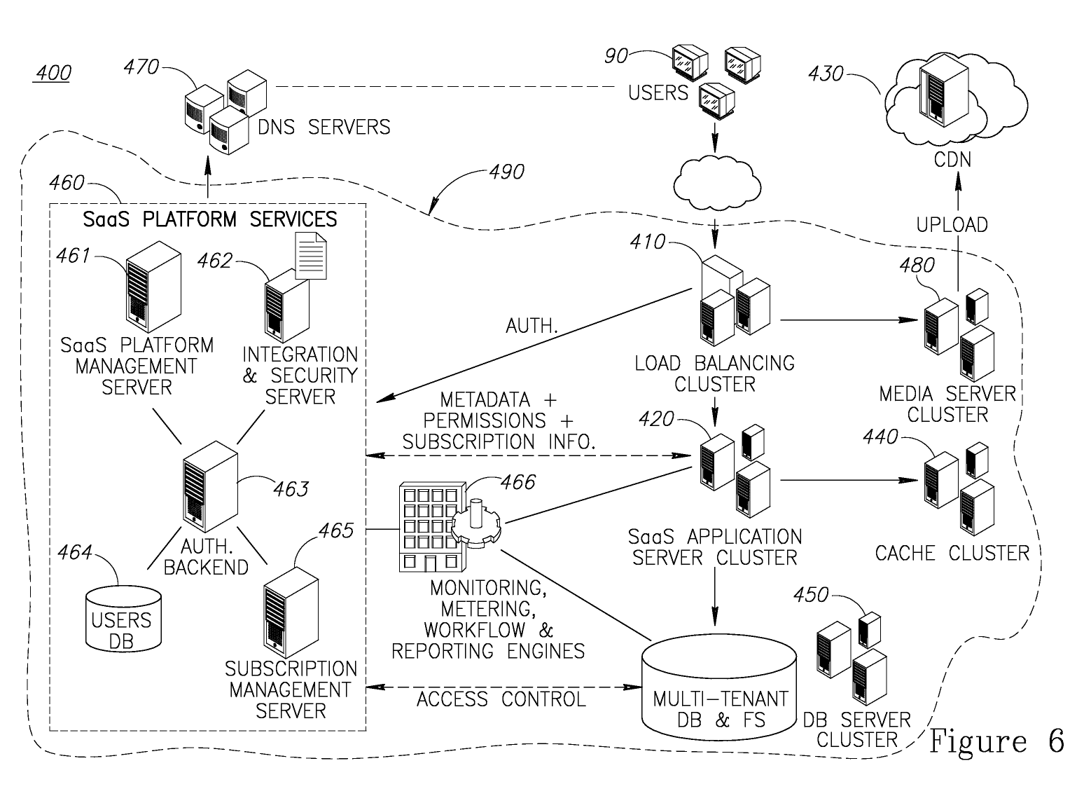

FIG. 6 is a block diagram illustrating an architecture of a SaaS platform, emphasizing the relationship between the system that is running the SaaS application on the SaaS platform and the system that is managing the computing resources of the platform and managing the access to the application and data via authentication backend system, according to some embodiments of the invention.

SaaS Platform is operating in an industry standard web application and scalable servers' stack. The stack includes the following elements: Load Balancing Cluster (LBC) 410 that is reducing load from SaaS Application Server Cluster (SASC) 420 and may perform as a web server. A login request may be directed by the load balancing cluster 410 to Authentication Backend (AB) 463. Content Delivery Network (CDN) 430 reduces load from datacentre in handling static files. Static files that were generated by the customer will be authorized by the customer before uploaded to the CDN.

In scalable systems, in order to achieve redundancy application, servers remain stateless and files are saved in cache memory 440. In this form stickiness between the user of a SA and the server is avoided. Further, application servers are separated from database servers 450 for redundancy and prevention of competition on computing resources.

Cache servers 440 assist application servers in reducing the need to rebuild Hyper Text Transfer Protocol (HTTP) Responses. The CDN 430, database server cluster 450, and cache cluster 440, may be separated physically or may be located on one server. In the present invention each of the aforementioned systems is modified to operate in a multi-tenant and secure manner and to meet standards of enterprise class SAs.

SaaS Platform Services Servers (SPSS) 460 is associated with the stack and, according to some embodiments of the invention, responsible for: separating the data of the application from the data of the customer, manage identity authentication and SAs licensing agreements, manage access permissions and the operations in the SAs and run the SA in an optimal manner. The SPSS may be logically and physically connected to the stack or connected logically only.

Mediator server 100 in FIG. 1 shown as SPSS 460 in FIG. 6 is responsible for enforcing ownership rights of the customer on the data while enabling the SD 95 to enforce licensing agreements and billing for usage of the SA.

The components operating in the SPSS 460 are: AB 463, Subscription Management Server (SMS) 465, Integration and Security Server 462, SaaS Platform Management Server (SPMS) 461 and Monitoring, Metering, Workflow and Reporting Engines 466.

AB 463, is performing identify authentication of the user in login into the SA, managing access permissions and usage of features and data in the SA. Further, enforcing these permissions in other systems in the platform. For example, multi-tenant file system.

SMS 465 is managing licensing agreements defined by the SD of the SA, managing subscription of users and billing the customers for SA usage and crediting the SD of the SA. SMS 465 may be connected via API to the enterprise SA of the SD to provide the SD real-time information regarding the usage of the SA.

Integration and Security Server 462 provides integration capabilities between a SA running on the SaaS platform and other business SAs that run on the site of the customer. For example, providing API to the data that is generated on the SA that is running on the SaaS platform and connecting this data to other business SAs that are running on the site of the customer. Further, Integration and Security Server 462 may integrate existing identity authentication means into the SA that is running on the SaaS platform. For example, Lightweight Directory Access Protocol (LDAP) or ActoveDirectory servers.

SPMS 461 is managing infrastructures of the platform, controlling processes running on the platform, managing servers, allocating and reallocating of computing resources, failure monitoring and sending real-time failure-notification to the SD. SPMS 461 is for the SD and the operators of the platform and is not accessible to the users of the SA.

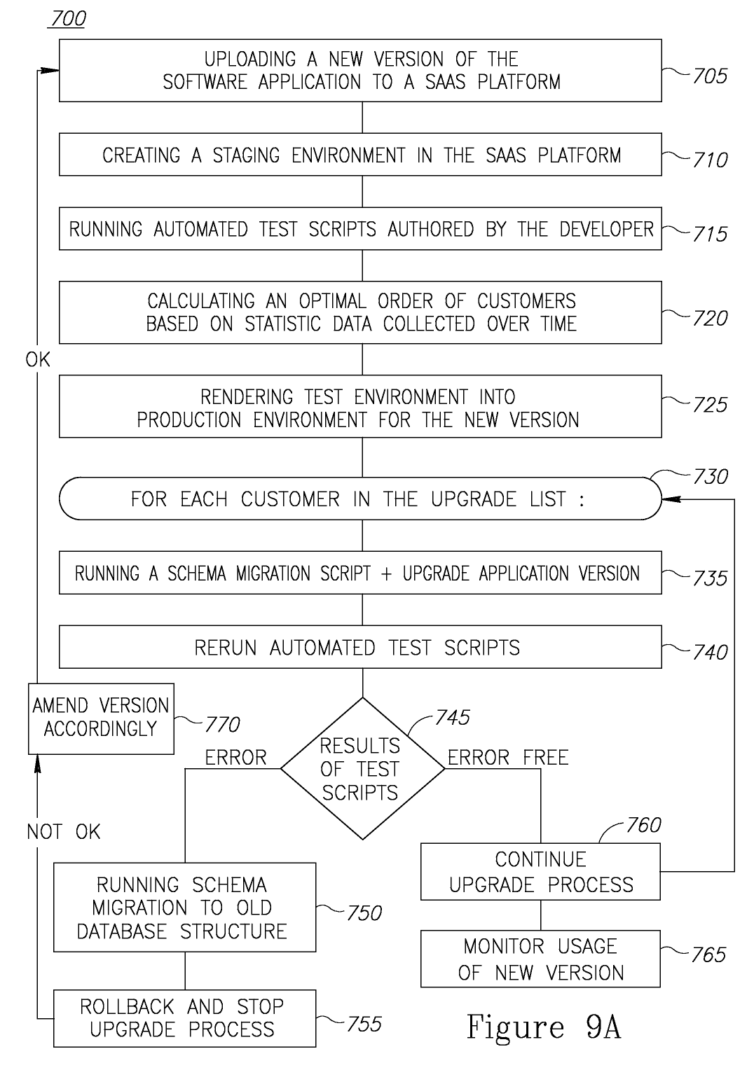

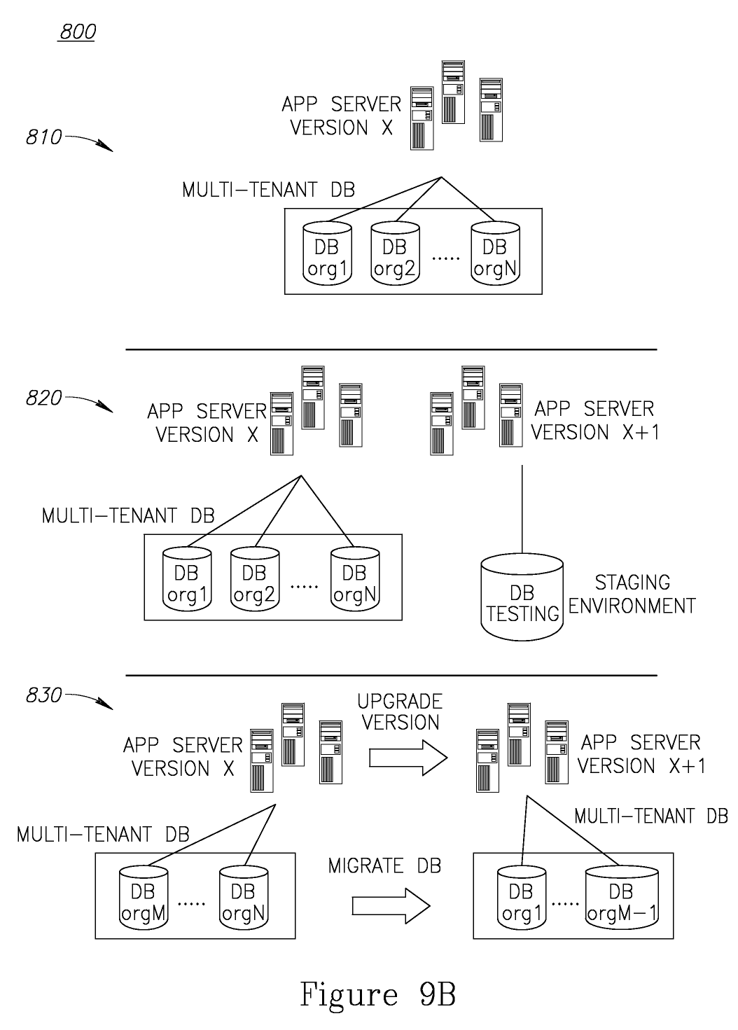

Further, SPMS 461 installs new SAs, managing transfer of data from one data storage provider to another as illustrated in FIG. 5 and managing upgrades of the SAs running on the SPSS 460 as will be illustrated later on in FIG. 9.

Monitoring, Metering, Workflow and Reporting Engines 466 is a collection of systems, providing information to different types of users and monitoring the workflow of the SA. Monitoring, Metering, Workflow and Reporting Engines 466 may be used by the users as well as by the SD and supervised by AB 463. Further, Monitoring, Metering, Workflow and Reporting Engines 466 may be used for billing purposes such as metering memory or computing resources consumption and for real-time monitoring of system health to provide reports as to system load, number of users and the like.

Managing customer identification of a user in the present invention is performed in a different way than is implemented in many SaaS applications which query customer identity of a user from a database of users. In the present invention user access to the application is unambiguous and separated in the level of Domain Name System (DNS) servers 470 by embedding customer ID in User Resource Identifier (URI) as a subdomain. For example, when the domain of the application is app.com then the SA of a user that belongs to customer X would be X.app.com. The SA that is referenced by X.app.com may be located in any datacenter.

An optional implementation of customer identification is by defining a unique one of A or CNAME record for each customer on the DNS servers 470 which manage app.com domain. SPMS 461 may automatically define one of: A, CNAME record when receives a request from SMS 465. A request from SMS 465 may occur during SA installation for a new customer as illustrated in FIG. 4, as well as in transferring the application from one data storage provider to another as illustrated in FIG. 5.

According to some embodiments of the invention, a central default datacenter is defined to manage transfers of access to domain such as X.app.com by a wildcard DNS record. This datacenter will handle incorrect references that mistakenly were directed to invalid datacenters due to asynchronous DNS servers and the like.

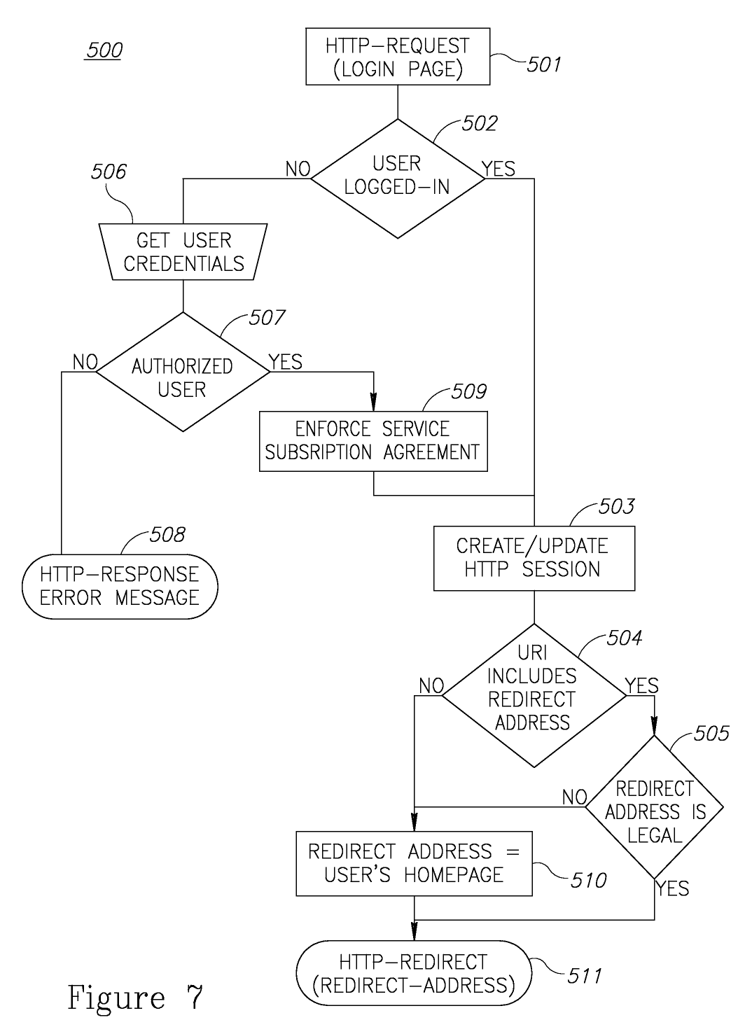

The present invention provides decentralized access to SAs running on the servers via DNS servers 470 with minimal access to a central server, as opposed to many SaaS platforms that exist in the market that are running in a centralized manner. The decentralization is possible, in the present invention, as a result of embedding the customer ID of the user in the URI. For example, a homepage 510 of each user as will be illustrated later on in FIG. 7.

Further, the present invention provides partitioning capabilities. The partitioning of the web servers and the SASC 420 is performed via LBC 410 which directs the traffic from users of a specific customer to a specific SA server or cluster or servers with no significance to HTTP sessions to retrieval of customer ID of a user from the username of the user.

The partitioning may be useful when more than one version of a SA exists and different customers are directed to different versions of the same SA. Another example of partitioning usage is when a user would like to have dedicated servers.

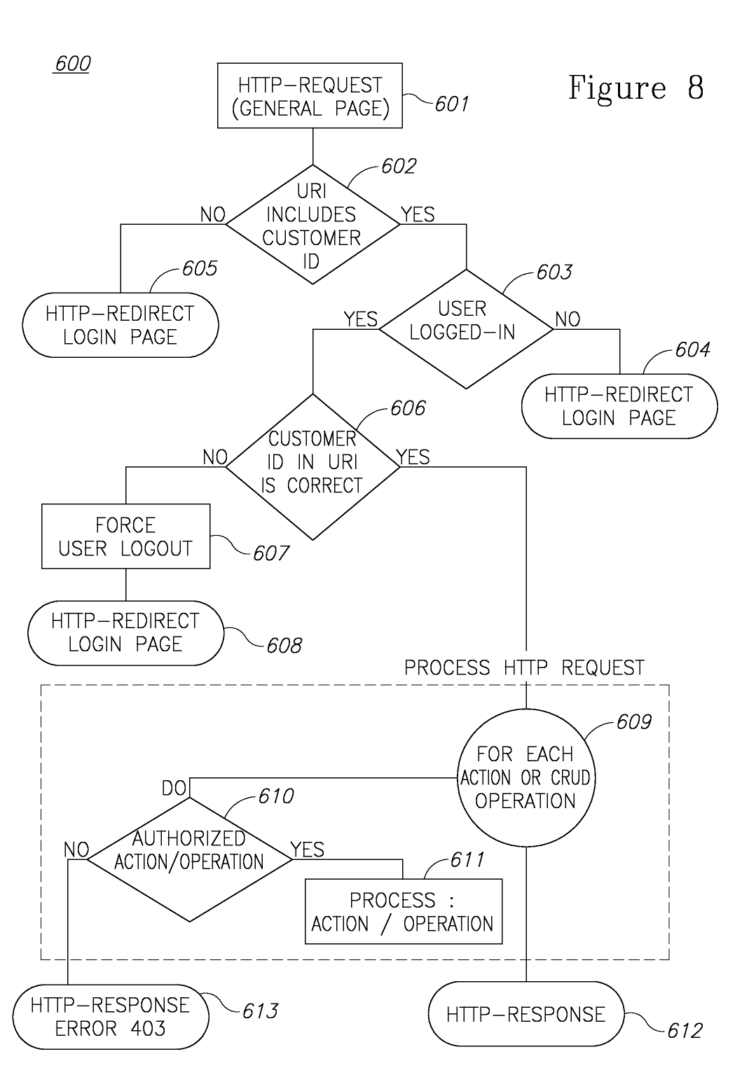

SASC 420 is running various SaaS applications over SaaS application Framework (FW) which is part it. The FW has various APIs to connect each of the SAs of the developers with the platform. For example, API to connect a SA to communicate with a database that is supervised by an authentication server as illustrated in FIG. 8. Another example is of SA query via an API the AB 463 as to permissions of user.

The present invention is managing access to SA and data via authentication backend system for all SAs as part of the SaaS platform. Further, according to some embodiments of the invention, data of customers may be secured throughout the system. Specifically, access to database and files, data placed while the application is running. In a non-limiting example, for full protection security mechanisms will be implemented in SASC 420 and in CC 410. As a result, implementation of secure access to a SA is minimal on a SD of each SA side.

Further, the present invention provides enforcement of licensing agreements of the SA and reduces integration issues of the application in the SaaS platform with other SAs exist on the datacenter of the customer or external SaaS applications.

Network 490 may be located in several datacenters in different locations. A customer may start working with a datacenter in one place and transfer to a datacenter located in another place as illustrated in FIG. 5. Relevant records in DNS servers 470 may be updated accordingly.

FIG. 7 is a high level schematic flowchart illustrating a method of identity authentication of a user as it implemented in the SaaS platform, according to some embodiments of the invention. Identity authentication process starts with HTTP Request from a user entering a login page of a SA i.e. URI (stage 501) running on AB servers 463 in FIG. 6. In case the user is successfully identified as an authorized user of the SA the page is redirected to a relevant URI.

The system checks if there is an open HTTP Session for the identified user i.e. the user of the application is already logged in (stage 502). If there is no open session or the session exists is expired i.e. the user of the application is not logged in, then credentials of the user are requested (stage 506).

User credentials may be a username and password or a cookie saved on the computer of the user or a Single Sign On (SSO) access control or the like. After a successful identification, the system checks if the user is authorized by the SA (stage 507). If the user is not listed as authorized user in the customer's Access Control List (ACL) to the SA, an error message will appear (stage 508). Other relevant licensing enforcements may be implemented (stage 509). For example, verify that the number of current users that are logged in is no larger than the number of users agreed on in the licensing agreement. Stage 509 is running on Subscription Management Server 465 in FIG. 6.

The system creates an HTTP Session when the user initially logged in (stage 503). The system updates existing HTTP Session when the user was already logged in (stage 503)

Before redirecting the user to a requested homepage, the system checks if the URI of the HTTP request i.e. the requested homepage, includes redirect address i.e. an address of a page shown after user identification (stage 504). The purpose of this stage is to prevent malicious breaks into the system.

If the URI includes the redirect address then the system will check if the user is authorized for the redirect address (stage 505). If the user is authorized then the system redirects to the requested homepage in the application (stage 511).

In case the URI does not include the redirect address or the user is not authorized for the redirect address then, the system will define the redirect address as the default homepage of the user in the SA (stage 510).

FIG. 8 is a high level schematic flowchart illustrating a process 600 of handling a page request of a user inside private zones of the SA, where identification is required, according to some embodiments of the invention. The purpose of this process is to assure each operation or information request in the application is within the scope of permissions of the specific user.

At first stage of the process, the system checks if the user who sent the HTTP request 601, accessed the correct URI that includes the customer ID 602. Then the system checks if the user has properly identified as illustrated in FIG. 7. If at least one of both checks is erred the user is redirected to login-page of the application 605, 604. If both checks are successful the system checks if the customer ID embedded in the URI is associated with the user 606. If it is not associated with the user a force of user logout 607 is performed and then redirect to login page 608.

At second stage of the process, the HTTP request is processed. The process may include a database access i.e. create, read, update, delete (CRUD) actions or functional operations such as report generation. Each action or operation is validated from two aspects 609. First, permissions in the user level and second, permissions in the customer subscription level. If successful the action or operation is processed 611. In case of a failure the user receives error notification 613. Only after all operations and requests were validated the user receives HTTP response 612.

FIG. 9A is a high level schematic flowchart illustrating a gradual upgrade of a SaaS application by a rolling upgrade, according to some embodiments of the invention. The purpose of the system for upgrading SA is to perform controlled and efficient SA version upgrades for both the developer and the customer. Further, this method reduces the load of technical support and customer service generally arises after an application upgrade.

Unaudited SA version upgrade i.e. upgrade to all customers of an application at one time may cause an overflow of users approaching the developer with various technical problems that may be an outcome of the upgrade.

In case the upgrade of SA version involves minor changes that does not require changes in database, the developer may choose simultaneous upgrade for all customers of the SA. For example, changes in a design of user interface.

The present invention provides a gradual SA version upgrade as illustrated in FIG. 9A. When changes in SA version upgrade involve require changes in database the developer may prefer to gradually upgrade SA version by a predefined order of customers.

The SD may upload a new version of SA to a SaaS platform (stage 705). Then, the SaaS platform creates a staging environment (stage 710). The SD of the new version of SA may run an automated test scripts (stage 715). An optimal order of customers to transfer to new version of SA may be calculated, based on statistic data, collected over time. For example, the time in the day in which the customer is less likely to use the SA, the number of users of each customer, level of satisfaction from service and the like (stage 720). Test environment becomes production environment for the new version of SA (stage 725). For each customer in the order of customers (stage 730): running a schema migration script and upgrade SA version (stage 735), then running automated test scripts (stage 740). Each SA version upgrade may include an automated test scripts i.e. unit tests, functional tests, behavior tests, regression tests and client side test.

When the upgrade involves changes in database the developer is required to provide database Schema Migration script to adjust the existing database to the new schema of the database and DB Schema Migration Rollback script to adjust the new database to the old schema of the database. These scripts may be produced by the SDK provided to the developer.

If the results of the automated test scripts (stage 745) are not error free for a specific customer a schema migration to old database is performed (stage 750) and then a rollback to previous SA version (stage 755). The Rollback capabilities and the ability to serve more than one version of the same SA are facilitated by the partitioning capabilities that were mentioned in FIG. 6. The SaaS Platform may stop the upgrade process at any time according to accumulated data as to the irregularity occurred during the upgrade (stage 755). After the new version of SA is amended (stage 770) a new version may be uploaded (stage 705).

In case the results of the automated test scripts (stage 745) are error free then upgrade is continued (stage 760) and test environment may become production environment for each SA that was upgraded (stage 725). Usage of new version of SA may be monitored to make sure that usage of SA was not decreased (stage 765).

Process 700 in FIG. 9A may run automatically and may not involve interference of the SD. Scheduling of process 700 may differ between customers according to their statistically low usage of the SA.

FIG. 9B is a high level block diagram illustrating a process of version upgrade in SaaS platform 800. The process 800 is an architectural aspect of the process that is illustrated in FIG. 9A.

In a regular run of SaaS platform, before an upgrade is performed, a multi-tenant database provides services to the SA servers of SaaS Platform (stage 810), then, as illustrated in stage 710 in FIG. 9A when a developer uploads a new version of SA, SaaS platform deploys the new SA on a new SA server and creates a logic database server that simulates the database of the customers for tests, migrations and the like. The developer does not have access to the real database of the customers (stage 820). Then, as illustrated in stage 730 in FIG. 9A SaaS platform gradually upgrades the SA for the customers to the new version by a calculated order. During the upgrade, as illustrated in FIG. 9A (stage 735) the new SA servers are defined to serve the customer and schema migration is running if needed (stage 830). A new SA server may be defined as a default server for a group of customers while serving other customers with the current SA server is facilitated by the partitioning capabilities that were mentioned in FIG. 6.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for managing a software as a service (SaaS) platform, comprising:
a mediator server connected to a plurality of computing resources, arranged to allow software developers to develop SaaS applications for multiple customers operable on the computing resources, and further arranged to allow customers to use the developed SaaS applications with specified customer data,
wherein the SaaS applications and the customer data are stored independently of the computing resources,
wherein the system is arranged to: (i) provide the SaaS applications via the mediator server directly to the customers, by the software developers, and (ii) ensure data availability and data security, independently of the computing resources used to run the SaaS applications, and
wherein the system is further arranged to determine a data storage provider in response to at least one of: customer selection and customer replacement of a data storage provider.

2. The system according to claim 1, wherein the mediator server is further arranged to separate data related to each SaaS application into application zone data and customer zone data and to provide user access to the customer zone data while controlling user access to the application zone data, and wherein the separation enables the mediator server to bill for application usage and provides the customer with access to raw data in the customer zone data independently of the mediator server.

3. The system according to claim 2, wherein the SaaS application comprises a user interface; a biz logic; and data structures, wherein the application zone data comprises the user interface; the biz logic; and a data connector, and wherein the customer zone data comprises the data structures and a data Application Programming Interface (API), wherein the data connector is arranged to communicate with the data API, and wherein the data API is arranged to provide data from the data structures to the data connector such that the application uses the data yet leaves data accessible to the customer independently of the application.

4. The system according to claim 3, wherein the data API is further arranged to manage data storage on various cloud hosting providers in a user transparent mode.

5. The system according to claim 3, wherein the data API is arranged to control resources dedicated to each application.

6. The system according to claim 5, wherein user access to the SaaS application is unambiguous and separated in a level of Domain Name System (DNS) servers by embedding customer identification (ID) of the user in User Resource Identifier (URI) as a subdomain.

7. The system according to claim 5, wherein the data API is further arranged to make available an analysis and a comparison of costs that are related to each application.

8. The system according to claim 3, wherein the data API is further arranged to wrap the data and metadata related to the application such that the wrap complies with data storage servers managed by the data storage provider.

9. The system according to claim 1, wherein the mediator server is further arranged to separate data related to each SaaS application into application zone data and customer zone data and wherein accessibility permissions to the customer zone data are determined by the customers.

10. The system according to claim 1, wherein the mediator server is further arranged to separate data related to each SaaS application into application zone data and customer zone data and to store them on an application zone data host and a customer zone data host respectively, and wherein the application zone data host and the customer zone data host are connected via a communication link.

11. The system according to claim 10, wherein the communication link is a Local Area Network (LAN) or a virtual Local Area Network (vLAN).

12. The system according to claim 10, wherein upon a transfer of the customer zone data to a new customer selected data storage server, the mediator server is further arranged to move the application zone data to a new application zone data host connected to the customer selected data storage server via the communication link.

13. The system according to claim 1, wherein upgrades to the SaaS applications are performed gradually in a predefined order of customers.

14. The system according to claim 1, further comprising a managing unit arranged to centrally manage the access of users and developers to the SaaS applications and further arranged to integrate the access of users with access to other applications.

15. A method of managing Software as a Service (SaaS) resources, comprising:
facilitating SaaS applications development environment and providing the SaaS applications to customers;
running the SaaS applications on a plurality of computing resources;
separating data related to each SaaS application into application zone data and customer zone data such that availability and security of the customer zone data, are ensured independently of the computing resources;
storing the customer zone data with a data storage provider defined by the customer, wherein the customer defined data storage is independent of the computing resources;
allowing the customer to replace the provider of the data storage; and
controlling user access to the application zone data, such that the applications are provided directly to the customers by the software developers.

16. The method according to claim 15, further comprising providing a development platform for software developers and supporting the developed software applications.

17. The method according to claim 15, further comprising selecting a data storage provider by the customer.

18. The method according to claim 15, further comprising moving the customer zone data from an initial customer zone host to an actual customer zone host, comprising:
generating and saving an initial state of the customer zone data on the initial customer zone host;
transferring the customer zone data from the initial customer zone host to the actual customer zone host;
generating an actual state of the customer zone data on the initial customer zone host; and
generating and transferring a difference between the actual and the initial states of the customer zone data to the actual customer zone host, whereupon the actual customer zone host starts operating with the actual state of data synchronized.

19. The method according to claim 15, further providing user access to the SaaS application in an unambiguous manner and separating in a level of Domain Name System (DNS) servers by embedding customer identification (ID) of the user in User Resource Identifier (URI) as a subdomain.

20. The method according to claim 18, wherein if a generation and transfer time of the difference is above a specified threshold, the moving is iterated with the actual state of the customer zone data being a new initial state of the customer zone data.

21. The method according to claim 18, further comprising moving the application zone data from an initial application zone host to an actual application zone host comprising:
translating the SaaS application;
moving the translated application to the actual application zone host; and
connecting the actual application zone host with the actual customer zone host via a communication link.

22. The method according to claim 20, wherein the communication link is a Local Area Network (LAN) or a virtual Local Area Network (vLAN).

23. The method according to claim 15, further comprising upgrading of SaaS applications, performed gradually and in a predefined order of customers.

24. The method according to claim 15, wherein access of users and developers to the SaaS application is centrally managed and further comprises integrating the access of users with access to other applications.
